(19) United States
(12) Patent Application Publication
(10) Pub. No.: US 2026/0024140 A1
(43) Pub. Date: Jan. 22, 2026

(54) SUPPORT APPARATUS, SUPPORT METHOD, AND NON-TRANSITORY COMPUTER-READABLE MEDIUM

(71) Applicant: NEC Corporation, Tokyo (JP)

(72) Inventors: Daichi IWATA, Tokyo (JP); Chika Asahina, Tokyo (JP); Mitsuhiro Watanabe, Tokyo (JP); Hirofumi Sato, Tokyo (JP)

(73) Assignee: NEC Corporation, Tokyo (JP)

(21) Appl. No.: 19/256,356

(22) Filed: Jul. 1, 2025

(30) Foreign Application Priority Data
Jul. 18, 2024 (JP) 2024-115039

(51) Int. Cl. G06Q 40/06

(52) U.S. Cl. CPC G06Q 40/062; G06Q 40/0631

(57) ABSTRACT

An object is to improve a technique of automatically determining whether to make an automatic response or to cause an operator to respond. A support apparatus includes a reception unit that receives a request related to asset management from a support subject, and a response control unit that determines whether to cause an operator to respond to the request or to make an automatic response to the request according to content of the request. According to this support apparatus, it is possible to support the decision making of a subject who manages assets.

### INCORPORATION BY REFERENCE

This application is based upon and claims the benefit of priority from Japanese patent application No. 2024-115039, filed on Jul. 18, 2024, the disclosure of which is incorporated herein in its entirety by reference.

### TECHNICAL FIELD

The present disclosure relates to a support apparatus, a support method, and a support program.

### BACKGROUND ART

In asset management, basic knowledge of asset management is required, and it is necessary to determine where to invest in consideration of individual circumstances for each manager such as the life stage of the manager and the managed fund. Thus, it is not easy for many people to manage assets by themselves, and there are many people who consult with asset management experts such as banks and financial planners in a case of starting asset management. As an easier introduction, it is also conceivable to use a service that provides information regarding asset management by an automatic response system.

However, since an automatic response has disadvantages such as difficulty in responding to unexpected questions and difficulty in responding to an advisee, it is desirable that the automatic response can be switched to a response of an operator as necessary. As related art related to switching from an automatic response to an operator response, for example, there is a multi-cloud chat service providing apparatus (hereinafter, abbreviated to a “providing apparatus”) disclosed in Patent Literature 1.

The providing apparatus disclosed in Patent Literature 1 can transmit a question message received from a user to an artificial intelligence (AI) chat cloud service to generate an answer message. The providing apparatus transmits a question message from the user to an operator terminal on condition that an operation of switching to operator handling has been performed by the user or the AI has not been able to reply, and causes the operator to input an answer.

Patent Literature 1: Japanese Unexamined Patent Application Publication No. 2019-128737

### SUMMARY

There is room for improvement in a method of automatically determining whether to make an automatic response or to cause an operator to respond in the providing apparatus disclosed in Patent Literature 1. For example, in the providing apparatus, in a case where the AI can reply, switching to operator handling is not performed regardless of the content of the reply. For this reason, it is difficult to avoid an inappropriate response of AI. For example, even in a case where a question from the user is a question that can lead to a contract with a large amount of money, such as a question regarding the management of a retirement allowance, in a case where the AI can reply, the switching to the operator handling is not performed. Therefore, there is a possibility that a business opportunity will be missed due to a uniform response of the AI.

The present disclosure has been made in view of such a problem, and an example object thereof is to improve a technique of automatically determining whether to make an automatic response or to cause an operator to respond.

A support apparatus according to an example aspect of the present disclosure is a support apparatus that supports asset management, and includes a reception unit that receives a request related to asset management from a support subject; and a response control unit that determines whether to cause an operator to respond to the request or to make an automatic response to the request according to content of the request.

A support method according to an example aspect of the present disclosure is a support method of supporting asset management, and includes a reception process in which at least one processor receives a request related to asset management from a support subject; and a response control process in which the at least one processor determines whether to cause an operator to respond to the request or to make an automatic response to the request according to content of the request.

A support program according to an example aspect of the present disclosure is a support program for causing a computer to function as a support apparatus that supports asset management, the support program causing the computer to function as a reception unit that receives a request related to asset management from a support subject; and a response control unit that determines whether to cause an operator to respond to the request or to make an automatic response to the request according to content of the request.

According to an example aspect of the present disclosure, there is an exemplary effect that it is possible to improve a technique of automatically determining whether to make an automatic response or to cause an operator to respond.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a support apparatus according to the present disclosure;

FIG. 2 is a flowchart illustrating a flow of a support method according to the present disclosure;

FIG. 3 is a block diagram illustrating a configuration of another support apparatus according to the present disclosure;

FIG. 4 is a diagram illustrating an example of support of the support apparatus illustrated in FIG. 3;

FIG. 5 is a flowchart illustrating a flow of a process executed by the support apparatus illustrated in FIG. 3; and

FIG. 6 is a block diagram illustrating a configuration of a computer that functions as the support apparatus according to the present disclosure.

### EXAMPLE EMBODIMENT

Hereinafter, example embodiments will be exemplified. However, the present disclosure is not limited to exemplary embodiments described below, and various alterations can be made within the scope described in the claims. For example, example embodiments obtained by appropriately combining techniques (some or all of things or methods) employed in the following exemplary embodiments can also be included in the scope of the present disclosure. Example embodiments obtained by appropriately omitting some of the techniques employed in the following exemplary embodiments can also be included in the scope of the present disclosure. Effects mentioned in the following exemplary embodiments are examples of effects expected in the exemplary embodiments, and do not define the extension of the present disclosure. That is, example embodiments that do not achieve the effects mentioned in the following exemplary embodiments can also be included in the scope of the present disclosure.

### First Exemplary Embodiment

A first exemplary embodiment, which is an example of an example embodiment, will be described in detail with reference to the drawings. The present exemplary embodiment is a basic form of each exemplary embodiment described below. An application scope of each technique employed in the present exemplary embodiment is not limited to the present exemplary embodiment. That is, each technique employed in the present exemplary embodiment can also be employed in the other exemplary embodiments included in the present disclosure within the scope in which no particular technical problem occurs. Each technique illustrated in the drawings referred to for describing the present exemplary embodiment can also be employed in the other exemplary embodiments included in the present disclosure within a range in which no particular technical problem occurs.

### Configuration of Support Apparatus 1

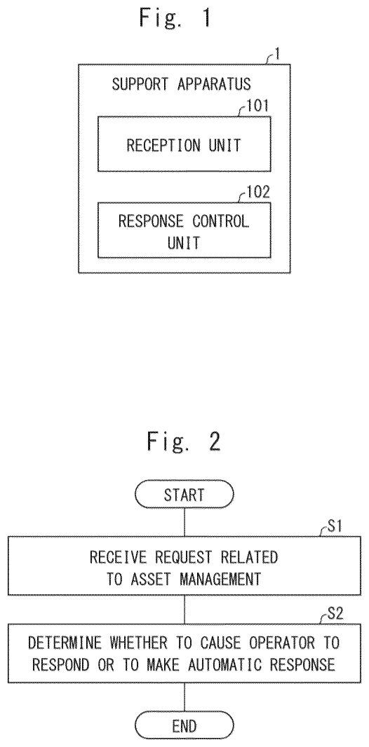

A configuration of a support apparatus 1 will be described with reference to FIG. 1. FIG. 1 is a block diagram illustrating a configuration of the support apparatus 1. The support apparatus 1 is an apparatus that supports asset management, and includes a reception unit 101 and a response control unit 102 as illustrated in FIG. 1. The support apparatus 1 has a function of executing various information processes described below, and can also be referred to as an information processing apparatus, a computer, or the like.

The reception unit 101 receives a request related to asset management from a support subject. The “subject” is a user of the support apparatus 1, and is typically a person who is considering performing asset management. The “request” indicates an item input to the support apparatus 1 by the subject to receive support for asset management. For example, a question about asset management and a request to present information regarding asset management are typical examples of the “request”. For example, a question or a checking message regarding a matter indirectly related to asset management (for example, stock market trends) is also included in the category of the “request”.

Any data format of the “request” may be employed. For example, in a case of supporting asset management in the form of text chat, the reception unit 101 may acquire a “request” input as text data. In a case where asset management is supported by the speech call, the reception unit 101 may acquire a “request” input as speech data. In this case, the reception unit 101 may convert the acquired speech data into text data by performing speech recognition.

The “request” may include data in a plurality of formats such as image (a still image or a moving image) data and text data. In this case, the reception unit 101 may convert a non-text element such as an image into a text format. For example, the reception unit 101 can perform such conversion by using a generation model subjected to machine learning in such a way that the generation model generates text indicating the content from the image. Such conversion and speech recognition may be performed by an apparatus other than the support apparatus 1.

The response control unit 102 determines whether to cause an operator to respond to the request or to make an automatic response to the request according to the content of the request received by the reception unit 101. A response of the operator may be made in any form. For example, a response of the operator may be made in a form of a text chat, or may be made in a form of a speech call. The speech call may be a video call accompanied with a video, or a response using both a speech call and a text chat may be made. The fact that a form of the response is optional also applies to the automatic response. An automatic response algorithm is also optional. For example, the automatic response may be made by using a rule base, or the automatic response may be made by using a language model.

The language model is a model obtained through machine learning of the arrangement of constituents (words and the like) in a sentence or the arrangement of a sentence and a sentence in a writing. For example, a generative pre-trained transformer (GPT) that outputs a sentence including an input character string by predicting a character string having a high probability of following the input character string may be used as the language model used for automatic response. For example, a text-to-text transfer transformer (T5), bidirectional encoder representations from transformers (BERT), a robustly optimized BERT approach (ROBERTa), or efficiently learning an encoder that classifies token replacements accurately (ELECTRA) may be used for automatic response.

After the response control unit 102 determines whether to cause the operator to respond to the request of the subject or to make an automatic response to the request, an apparatus that responds to the subject may be the support apparatus 1 or another apparatus. For example, in a case where the response control unit 102 determines to cause the operator to respond, the response control unit may cause the operator to respond to the subject via a terminal apparatus used by the operator. In a case where it is determined to make the automatic response, the response control unit 102 may transfer the subject's request to an external information processing apparatus having an automatic response function, and cause the information processing apparatus to respond to the request.

As described above, the support apparatus 1 is a support apparatus that supports asset management, and includes the reception unit 101 that receives a request related to asset management from a support subject, and the response control unit 102 that determines whether to cause an operator to respond to the request or to make an automatic response to the request according to the content of the request.

According to the above configuration, it is determined whether to cause the operator to respond to the request or to make an automatic response to the request according to the content of the received request. Therefore, it is possible to make an appropriate response according to the content of the received request. As described above, according to the support apparatus 1, it is possible to achieve an effect that it is possible to improve a technique of automatically determining whether to make an automatic response or to cause an operator to respond. According to the support apparatus 1, it is possible to support the decision making of the subject in the asset management by appropriately responding to the request of the subject.

### Support Program

The function of the support apparatus 1 described above can also be achieved by a program. A support program according to the present exemplary embodiment is a support program that causes a computer to function as a support apparatus that supports asset management, and causes the computer to function as reception means for receiving a request related to asset management from a support subject; and response control means for determining whether to cause an operator to respond to the request or to make an automatic response to the request according to content of the request. According to this support program, it is possible to improve a technique of automatically determining whether to make an automatic response or to cause an operator to respond.

### Flow of Support Method

A flow of a support method will be described with reference to FIG. 2. FIG. 2 is a flowchart illustrating a flow of the support method. An executing entity of each step in this support method may be a processor included in the support apparatus 1, may be a processor included in another apparatus, or may be a processor provided in an apparatus in which executing entities of each step are different.

In S1 (reception process), at least one processor receives a request related to asset management from a support subject.

In S2 (response control process), at least one processor determines whether to cause an operator to respond to the request or to make an automatic response to the request according to the content of the request received in S1.

It may be determined whether to cause the operator to respond to the received request or to make an automatic response to the request at a point of time before the process in S2 is performed. In this case, in S2, it may be determined whether to switch aspects of a response to the request received in S1. That is, in a case where it is determined to cause the operator to respond to the received request at a point of time before the process in S2 is performed, in S2, it is only required to determine whether to switch a response to the request received in S1 to an automatic response. On the other hand, in a case where it is determined to make an automatic response to the received request at a point of time before the process in S2 is performed, in S2, it may be determined whether to switch a response to the request received in S1 to causing the operator to respond. Even in a case where such a determination is made, it is substantially “determined whether to cause the operator to respond to the request or to make an automatic response to the request”.

As described above, the support method according to the present exemplary embodiment is a support method of supporting asset management, and includes a reception process in which at least one processor receives a request related to asset management from a support subject; and a response control process in which the at least one processor determines whether to cause an operator to respond to the request or to make an automatic response to the request according to content of the request. Therefore, according to the support method of the present example embodiment, it is possible to improve a technique of automatically determining whether to make an automatic response or to cause an operator to respond.

### Second Exemplary Embodiment

A second exemplary embodiment, which is an example of an example embodiment, will be described in detail with reference to the drawings. Constituents having the same functions as the constituents described in the above-described exemplary embodiment are denoted by the same reference signs, and the description thereof will be appropriately omitted. An application scope of each technique employed in the present exemplary embodiment is not limited to the present exemplary embodiment. That is, each technique employed in the present exemplary embodiment can also be employed in the other exemplary embodiments included in the present disclosure within the scope in which no particular technical problem occurs. Each technique illustrated in each of the drawings referred to for describing the present exemplary embodiment can be employed in the other exemplary embodiments included in the present disclosure within the scope in which no particular technical problem occurs.

### Configuration of Support Apparatus 1A

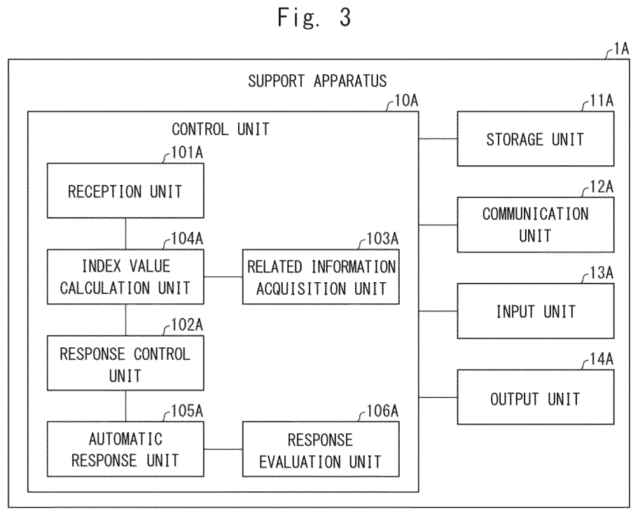

A configuration of a support apparatus 1A will be described with reference to FIG. 3. FIG. 3 is a block diagram illustrating a configuration of the support apparatus 1A. The support apparatus 1A is an apparatus having a function of supporting asset management. The support apparatus 1A may be an apparatus of which a main function is to support asset management, or may be a general-purpose apparatus having other functions. The support apparatus 1A may be a stationary apparatus or a portable apparatus.

As illustrated in FIG. 3, the support apparatus 1A includes a control unit 10A that integrally controls each unit of the support apparatus 1A and a storage unit 11A that stores various data used by the support apparatus 1A. The support apparatus 1A includes a communication unit 12A for the support apparatus 1A to communicate with another apparatus, an input unit 13A that receives an input to the support apparatus 1A, and an output unit 14A for the support apparatus 1A to output data. The control unit 10A includes a reception unit 101A, a response control unit 102A, a related information acquisition unit 103A, an index value calculation unit 104A, an automatic response unit 105A, and a response evaluation unit 106A. Details of the index value calculation unit 104A and the response evaluation unit 106A will be described later.

Similarly to the reception unit 101 described in the first exemplary embodiment, the reception unit 101A receives a request related to asset management from a support subject. In the present exemplary embodiment, an example of supporting asset management through a speech call will be described. Thus, the reception unit 101A receives an input of speech data indicating the content of a request of the subject regarding asset management, recognizes the speech data, and converts the speech data into a text format. The process in the case of supporting asset management by exchanging text such as text chat is similar to the process in the support by a speech call, except that a request from the subject is received in text and a response to the subject is displayed as text.

Similarly to the response control unit 102 described in the first exemplary embodiment, the response control unit 102A determines whether to cause the operator to respond to the request or to make an automatic response to the request according to the content of the request received by the reception unit 101A. As described above, in the present exemplary embodiment, an example of supporting asset management through a speech call will be described. Thus, in a case where the operator is caused to make a response, the response control unit 102A transfers an incoming call from the subject to the operator. On the other hand, in the case where an automatic response is made, the response control unit 102A causes the automatic response unit 105A to make a response. The response control unit 102A may use related information described below in a case of determining whether to cause the operator to respond or to make an automatic response.

The related information acquisition unit 103A acquires related information used for determining whether to cause the operator to respond or to make an automatic response. The related information may be any information useful from the viewpoint of determining whether to cause the operator to respond or to make an automatic response. For example, the related information acquisition unit 103A may acquire related information indicating an attribute of the subject. Examples of the attribute of the subject include personal characteristics (age, sex, occupation, held assets, past asset management history, and the like) registered in advance by the subject.

For example, the related information acquisition unit 103A may acquire an image (which may be a still image or a moving image) obtained by imaging the subject, speech data of speaking of the subject, measurement data from various sensors (for example, an acceleration sensor, a temperature sensor, a heart rate sensor, and a perspiration sensor) worn by the subject, and the like as the related information. As described above, the related information acquisition unit 103A may acquire data of a plurality of modalities (data formats) as related information.

The related information acquisition unit 103A can detect the current emotion of the subject and a change in the emotion by analyzing the data related to the emotion of the subject. By using the analysis results, the response control unit 102A can determine whether to cause the operator to respond or to make an automatic response in consideration of the subject's emotion and the change in the emotion. For example, in a case where the subject's emotion deteriorates immediately after presenting an answer through the automatic response, the response control unit 102A may perform switching to the response of the operator. The data may be analyzed by the related information acquisition unit 103A, or a result analyzed by another apparatus may be acquired as the related information.

The automatic response unit 105A is for making an automatic response to the request of the subject. The fact that an automatic response algorithm is optional is as described in the first exemplary embodiment. In the present exemplary embodiment, an example in which the automatic response unit 105A makes an automatic response of using a language model will be described. In this case, the automatic response unit 105A inputs text indicating the content of a request of the subject to the language model to generate an answer to the request. The automatic response unit 105A presents the generated answer to the subject. In the present exemplary embodiment, since the asset management is supported through the speech call, the automatic response unit 105A may convert the generated answer into speech data and transmit the speech data to a terminal apparatus of the subject via a communication line. The conversion into the speech data may be executed by another apparatus different from the support apparatus 1A.

As described above, the support apparatus 1A includes the reception unit 101A that receives a request related to asset management from a support subject, and the response control unit 102A that determines whether to cause an operator to respond to the request or to make an automatic response to the request according to the content of the request received by the reception unit 101A. Therefore, similarly to the support apparatus 1 of the first exemplary embodiment, it is possible to achieve an effect that it is possible to improve the technique of automatically determining whether to make an automatic response or to cause an operator to respond.

### Example of Support

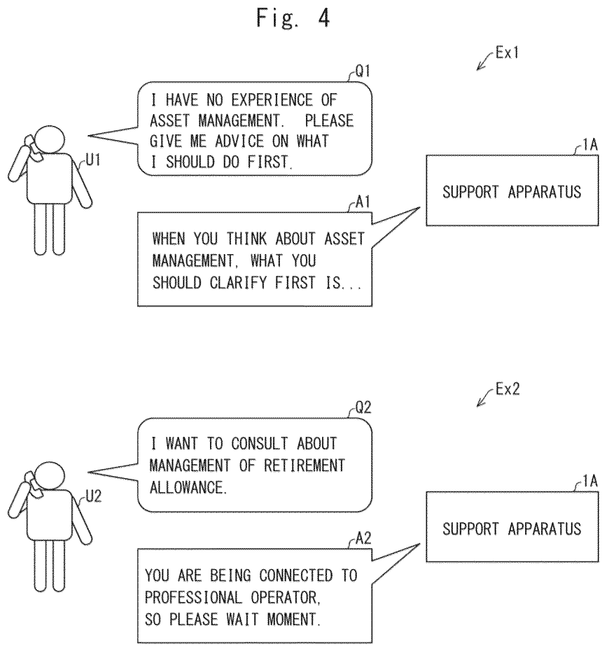

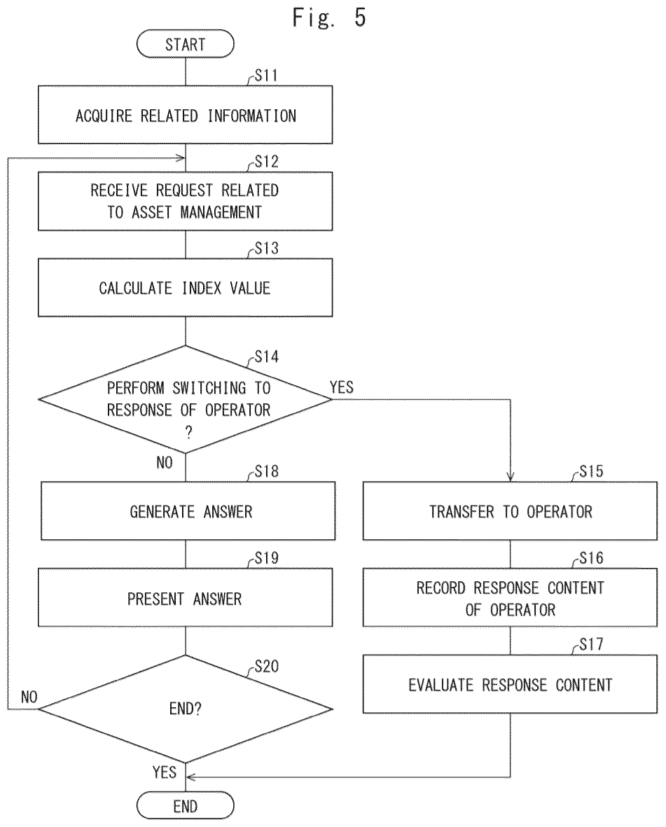

FIG. 4 is a diagram illustrating an example of support of the support apparatus 1A. More specifically, FIG. 4 illustrates two examples Ex1 and Ex2. In Ex1 and Ex2, supported subjects are different U1 and U2, and the content of requests made to the support apparatus 1A is different between the subjects U1 and U2.

In Ex1, the subject U1 is in a call state with the support apparatus 1A, and makes an utterance Q1 asking for advice on what should be first performed in starting asset management. The reception unit 101A of the support apparatus 1A receives the utterance Q1 as a request related to asset management from the subject U1. The response control unit 102A determines whether to cause the operator to respond to the request or to make an automatic response to the request according to the content of the request.

Here, the content of the utterance Q1 in Ex1 is to seek general information necessary for starting asset management, and it is considered that there is a high possibility that the automatic response unit 105A can provide a response satisfying the subject U1. Therefore, in Ex1, the response control unit 102A determines to make an automatic response, and thus an answer A1 generated by the automatic response unit 105A is presented to the subject U1.

A specific method for the response control unit 102A to make such a determination will be described later. In FIG. 4, the answer A1 is indicated by a balloon associated with the support apparatus 1A, but actually, the answer A1 is output from a speech output unit of an earpiece held by the subject U1. The same applies to an answer A2 in Ex2 described below.

In Ex2, the subject U2 is in a call state with the support apparatus 1A and makes an utterance Q2 indicating that the subject U2 wants to consult about the management of a retirement allowance. The reception unit 101A of the support apparatus 1A receives the utterance Q2 as a request related to asset management from the subject U2. The response control unit 102A determines whether to cause the operator to respond to the request or to make an automatic response to the request according to the content of the request.

The content of the utterance Q2 in Ex2 is that the subject wants to consult about the management of a retirement allowance, and if the management of the retirement allowance can be entrusted, a relatively large profit is expected, and thus, it is considered that a response of the operator is desirable. Therefore, in Ex2, the response control unit 102A determines to cause the operator to respond, and presents the answer A2 indicating that the call is transferred to the operator to the subject U2. Although not illustrated, the subject U2 and the operator are then in a call state, and the subject U2 can consult with the operator about management of the retirement allowance.

### Determination Example 1 of Response Control Unit 102A: Determination Based on Index Value

Here, as illustrated in FIG. 3, the support apparatus 1A includes an index value calculation unit 104A. The index value calculation unit 104A calculates an index value for determining whether to switch to a response of the operator based on the content of the request of the subject during the period in which the automatic response is applied. The response control unit 102A determines whether to switch a response to the subject to the response of the operator based on the index value calculated by the index value calculation unit 104A. As a result, in addition to the effects achieved by the support apparatus 1, it is possible to switch from the automatic response to the response of the operator at an appropriate timing.

In a case where a new request from the subject is received, the index value calculation unit 104A may update the index value calculated most recently based on the content of the new request. Alternatively, in a case where a new request from the subject is received, the index value calculation unit 104A may recalculate an index value based on the content of the new request and the content of a series of requests received until the new request is received. According to such a configuration, in addition to the effects achieved by the support apparatus 1, it is possible to achieve an effect that switching from the automatic response to the response of the operator can be performed at an appropriate timing in consideration of a plurality of requests received during the period in which the automatic response is applied.

A method of calculating an index value is not particularly limited. For example, the index value calculation unit 104A may calculate an index value by using an index value calculation model generated through machine learning of a relationship between a request from a subject supported for asset management and an index value indicating the necessity of causing an operator to respond to the request. As a result, in addition to the effects achieved by the support apparatus 1, it is possible to switch from the automatic response to the response of the operator at an appropriate timing based on a result of the machine learning.

It is also possible to use a language model instead of the above index value calculation model. In this case, the index value calculation unit 104A may generate a prompt including a request from a subject supported for asset management and giving an instruction to output an index value indicating the necessity of causing an operator to respond to the request, and input the generated prompt to the language model. As a result, the index value is output from the language model. In the case of using the language model, a prompt for asking about whether to cause the operator to respond or to make an automatic response may be used. In this case, the response control unit 102A may determine whether to cause the operator to respond or make an automatic response according to the output of the language model for the prompt. It is not necessarily to input the entire text of the request of the subject to the language model, and a summary of the request of the subject, a word extracted from the request of the subject, or the like may be input to the language model. The same applies to the case of using the above-described index value calculation model.

For example, a plurality of keywords or phrases serving as a material for determining whether to cause the operator to respond or to make an automatic response may be set in advance, and an evaluation value may be set in advance for each keyword or phrase. For example, it is conceivable to set an evaluation value indicating that it is necessary to cause the operator to respond for keywords such as an “operator” and a “person in charge”. It is conceivable to set an evaluation value indicating that it is necessary to cause the operator to respond for a negative keyword or phrase for the current response such as “not easy to understand” or “not that”. By setting the keywords or phrases and the evaluation values as described above, the index value calculation unit 104A can detect the keywords from the request of the subject and calculate a sum of the evaluation values set for the detected respective keywords as an index value of the request.

In the support of asset management of the support apparatus 1A, an operator may give advice on asset management based on information collected at the time of automatic response (for example, a period during which the automatic response unit 105A and the subject freely interact with each other). In this case, the index value calculation unit 104A may calculate an index value indicating a collection status of information necessary for advice of the operator. In this case, the response control unit 102A may perform switching to the response of the operator in a case where the calculated index value is equal to or more than a predetermined threshold. For example, the index value may be calculated by listing information necessary for advice in advance and comparing the information collected at the time of automatic response with the list.

In a case of considering asset management, a portfolio is first determined, and then specific investment destinations such as selection of financial products are often examined according to the portfolio. The “portfolio” in asset management indicates asset allocation. For example, it is assumed that assets of 10 million yen are equally invested and managed in each of domestic stocks, domestic bonds, foreign stocks, and foreign bonds. The portfolio in this case would allocate 25% of each asset to domestic stocks, domestic bonds, foreign stocks, and foreign bonds. An allocation destination is optional, and for example, financial assets such as deposits and insurance, and real assets such as real estate and precious metals may be included in the allocation destination.

Therefore, first, the automatic response unit 105A may present a question for eliciting information necessary for determining a portfolio to the subject and acquire an answer of the subject to the question. The response control unit 102A may perform switching to the response of the operator at the time at which the collection of information necessary for determining the portfolio is completed. As a result, the operator can create a portfolio based on the collected information and give consultation to the subject about asset management based on the portfolio.

The support apparatus 1A may also generate a portfolio. For example, by setting a rule for generating a portfolio according to an answer of the subject in advance, it is possible to automatically generate the portfolio in accordance with the rule. For example, it is also possible to input answers of the subject to the language model and generate a portfolio suitable for the subject ascertained from the answers. Instead of generating a portfolio, a plurality of patterns of portfolios may be prepared in advance, and a portfolio suitable for the subject may be selected and presented from among the portfolios based on answers of the subject.

### Determination Example 2 of Response Control Unit 102A: Determination Based on Evaluation Result for Expected Profit

The response control unit 102A may determine whether to cause an operator to respond to a subject or to make an automatic response based on at least one of an evaluation result for a profit expected to be obtained by causing the operator to respond to a request of the subject and an evaluation result for a profit expected to be obtained by making an automatic response to the request of the subject. Thus, in addition to the effects achieved by the support apparatus 1, it is possible to achieve an effect of increasing a profit to be obtained by a response to a subject.

Any method of evaluating an expected profit may be employed. For example, in a case where a request from a subject includes an amount of money to be managed by the subject or content suggesting an amount of managed money, the response control unit 102A may evaluate an expected profit from such content. As a specific example, if keywords such as “retirement allowance” and “succession” are included in the request from the subject, the response control unit 102A may evaluate that the expected profit in a case where the operator is caused to respond is large and determine to cause the operator to respond (see Ex2 in FIG. 4). On the other hand, in a case where a keyword of “inexperience” is included in the request from the subject, the response control unit 102A may evaluate that an expected profit in a case where the operator is caused to respond is small and determine to set the automatic response (see Ex1 in FIG. 4).

For example, the response control unit 102A may predict an expected profit by using a prediction model for predicting the expected profit (obtained through machine learning of a relationship between the request and the expected profit) or a language model. The evaluation of an expected profit may be performed separately from the calculation of the index value described above, or an index value including the expected profit may be calculated. In the former case, the response control unit 102A may determine whether to cause the operator to respond to the subject or to make an automatic response based on both the evaluation result for the expected profit and the index value. In the latter case, the index value may be calculated in consideration of elements related to the expected profit (for example, a keyword such as a “retirement allowance” included in the request, or the age, the income, and the like of the subject specified from the related information of the subject).

### Another Example of Determination of Response Control Unit 102A

Here, there are countries and regions in which there are provisions prohibiting an action of recommending a financial product in an automatic response system. Therefore, in a case where the content of a request of a subject is a request for a proposal of a financial product to be invested, the response control unit 102A may determine to cause an operator to respond to the request. As a result, in addition to the effects achieved by the support apparatus 1, it is possible to achieve an effect that it is possible to observe the above provisions by switching to the operator response as necessary while using the automatic response.

Any method of determining whether the content of the request of the subject is a request for a proposal of a financial product to be invested may be employed. For example, in a case where a predetermined keyword or phrase such as a name of a financial product is included in the request of the subject, the response control unit 102A may determine that there is a possibility that the request is a request for a proposal of a financial product and cause the operator to respond. For example, the response control unit 102A may input the request of the subject to the language model, and may determine whether the request is a request for a proposal of a financial product.

In providing a service related to asset management, there is an action permitted only to a person having a predetermined qualification. Therefore, in a case where the content of the request of the subject indicates that a response of a qualified person having a predetermined qualification is required for the request, the response control unit 102A preferably determines to cause the operator who is a qualified person to respond to the request. As a result, in addition to the effects achieved by the support apparatus 1, it is possible to cause a qualified person to respond to a request to which the qualified person needs to respond while using the automatic response.

Any method of determining whether a response of a qualified person is necessary may also be employed. For example, the response control unit 102A may determine whether a response of a qualified person is necessary based on whether a predetermined keyword or phrase that is often included in a request to which a qualified person needs to respond is included in the request of the subject. For example, the response control unit 102A may input a request of the subject to the language model to determine whether a qualified person needs to respond to the request.

There may be a plurality of operators, and the plurality of operators may include a qualified person and an unqualified person. In such a case, the response control unit 102A causes an operator having a qualification necessary for responding to the subject's request among the plurality of operators to respond to the request. In a case where there is no operator having the qualification necessary for responding to the request of the subject or in a state in which such an operator cannot respond to the subject, the response control unit 102A may present a message indicating that it is difficult to respond to the subject.

In a case where a plurality of operators are present, the response control unit 102A preferably causes an operator who is compatible with the subject among the plurality of operators to respond to the request of the subject. Any method of estimating the compatibility between the subject and the operator may be employed. For example, it is also possible to estimate an operator who is compatible with the subject from the content of the request of the subject or the related information of the subject.

A plurality of types of language models for automatic response may be prepared. In this case, the response control unit 102A may make a response to the request of the subject by applying a language model that is compatible with the subject or a language model suitable for the content of the request of the subject among the plurality of language models. For example, a language model A (for example, a general-purpose language model finely tuned with life planning consultation cases) for life planning consultation and a language model B (for example, a general-purpose language model finely tuned with financial product consultation cases) for financial product consultation may be prepared in advance. In this case, if the request of the subject relates to life planning, the response control unit 102A causes the automatic response unit 105A to automatically respond by using the language model A. On the other hand, if the request of the subject relates to consultation about a financial product, the response control unit 102A causes the automatic response unit 105A to automatically respond by using the language model B. It is also possible to achieve a similar response by processing a prompt. For example, it is also possible to generate a response suitable for life planning by causing a sentence such as “please answer as a life planning expert” to be included in a prompt or causing a set of a request and a model answer in life planning to be included as an answer example.

### Response Evaluation

Here, since an operator is a person, it is difficult to always make an appropriate response to the subject, and sometimes the operator makes an inappropriate response. The response evaluation unit 106A is provided in the support apparatus 1A from such a viewpoint (see FIG. 3).

The response evaluation unit 106A evaluates the content of the response of the operator. According to the support apparatus 1A including the response evaluation unit 106A, it is possible to achieve an effect of improving the quality of the response of the operator in addition to the effects achieved by the support apparatus 1. For example, the evaluation result from the response evaluation unit 106A may be sent to the operator himself/herself and/or a manager such as his/her supervisor to urge improvement of the response quality.

For example, the response control unit 102A may determine whether it is necessary to change the operator based on the evaluation result for the operator from the response evaluation unit 106A during the operator's response to the subject. As a result, it is possible to prevent deterioration of an impression of the subject due to continuation of a response of an operator who has not made an appropriate response to the subject.

The evaluation criteria for response content may be determined in advance. As a method of evaluating the response content, any method in accordance with the evaluation criteria may be applied. For example, the presence or absence of a compliance problem in the response content of the operator may be used as an evaluation criterion. In this case, for example, the response evaluation unit 106A may summarize the response content of the operator (and the request content of the subject) with a language model, and determine whether the summarized response content has a compliance problem. The presence or absence of a problem may also be determined by a language model. The response evaluation unit 106A may determine the presence or absence of a problem by presenting a summary to a predetermined judge who determines the presence or absence of a compliance problem and inputting a determination result of the judge to the support apparatus 1A. In this case, the determination result input by the judge is an evaluation result for the response content from the response evaluation unit 106A.

The response control unit 102A can also evaluate the response content of the automatic response in a similar manner. However, in order to evaluate the response content of the automatic response, it is necessary to record not only the response content of the automatic response in the period in which the automatic response is applied but also the request or the like of the subject in the same period. Performing such recording may hinder free utterance of the subject on the premise of automatic response (that is, not being heard by a person). Therefore, the response control unit 102A may record and evaluate the content of the response of the operator (and the content of the request of the subject), and may not record and evaluate the response content of the automatic response (and the content of the request of the subject).

### Flow of Process

A flow of processing executed by the support apparatus 1A will be described with reference to FIG. 5. FIG. 5 is a flowchart illustrating an example of a process executed by the support apparatus 1A. FIG. 5 includes each process of the support method according to the present exemplary embodiment. FIG. 5 illustrates an example in which an automatic response is basically used, and the response is switched to an operator's response as necessary.

In S11, the related information acquisition unit 103A acquires related information that is information used for determining whether to cause the operator to respond or to make an automatic response. A method of acquiring the related information is arbitrary. For example, the related information acquisition unit 103A may acquire the related information input by a support subject via the communication unit 12A or the input unit 13A, or may acquire the related information from a predetermined acquisition destination (for example, a database in which the related information of the support subject is recorded in advance).

In S12 (reception process), the reception unit 101A receives a request related to asset management from the support subject. In a case of supporting asset management through a speech call, the reception unit 101A receives a request (specifically, input of speech data indicating the content of the request) from the subject via the call with the subject. The reception unit 101A performs speech recognition on the speech data and converts the speech data into a text format. As described above, here, since the automatic response is the basic response method, the automatic response is applied at the time at which the process in S12 is performed.

In S13, the index value calculation unit 104A calculates an index value for determining whether to switch to the response of the operator based on the content of the request of the subject received in S12. As described above, the response control unit 102A may also determine whether to cause the operator to respond or to make an automatic response without using the index value. For example, the response control unit 102A may determine whether to cause the operator to respond or to make an automatic response based on an evaluation result for an expected profit. In this case, an evaluation for the expected profit is performed in S13. The response control unit 102A may determine whether to cause the operator to respond or to make an automatic response depending on whether a predetermined keyword or phrase is included in the request of the subject. In this case, a keyword or a phrase is extracted in S13.

In S14 (response control process), the response control unit 102A determines whether to switch the response to the subject to the response of the operator based on the index value calculated in S13. In other words, the response control unit 102A determines whether to cause the operator to respond to the request or to make an automatic response to the request according to the content of the request received in S12. In S14, the response control unit 102A may also perform determination by using the related information acquired in S11. In a case where YES is determined in S14 (the operator is caused to respond), the process proceeds to S15. On the other hand, in a case where NO is determined in S14 (the automatic response is maintained), the process proceeds to S18.

In S15, the response control unit 102A transfers an incoming call from the subject to the operator. In this case, the response control unit 102A may present a message indicating that the transfer to the operator is performed to the subject as in Ex2 in FIG. 4. The response control unit 102A may transmit the request (specifically, speech data) received in S12 to the operator. In a case where the transfer of the incoming call is completed, a response of the operator is started.

In S16 after the response of the operator is started, the response evaluation unit 106A starts recording the response content of the operator. In the case of supporting the asset management through the speech call, the response evaluation unit 106A records the call content between the operator and the subject in S16. The recording of the response content is continued until the response of the operator is ended.

In S17 after the response of the operator is completed, the response evaluation unit 106A evaluates the response content of the operator based on the data recorded during the response of the operator. As described above, the response evaluation unit 106A may feed back the evaluation result to the operator, his/her supervisor, or the like. Accordingly, the process in FIG. 5 is ended. It is also possible to switch to the automatic response during the response of the operator.

In S18, the automatic response unit 105A causes the language model to generate an answer to the request received in S12. In S18, the automatic response unit 105A may also generate an answer by using the related information acquired in S11.

In S19, the automatic response unit 105A presents the answer generated in S18 to the subject. Specifically, the automatic response unit 105A converts the answer generated in S18 into speech data and transmits the speech data to the subject, thereby presenting the answer to the subject.

In S20, the reception unit 101A determines whether to end the reception of the request. In a case where the asset management is supported through the speech call, the reception unit 101A ends the reception of the request once the subject ends the call. In a case where YES is determined in S20, the process in FIG. 5 is ended.

On the other hand, in a case where NO is determined in S20, the process returns to S12, and a new request from the subject is received. In S13, the index value calculation unit 104A recalculates an index value based on a new request from the subject and the request received in the first S12. For example, the index value calculation unit 104A may recalculate the index value by inputting a new request from the subject and the request received in the first S12 to an index value calculation model. The same applies to the third and subsequent S13, and the index value calculation unit 104A recalculates the index value based on a new request from the subject and each request received so far. As described above, the index value may be updated based on a new request every time a new request is received, instead of recalculating the index value every time a new request is received.

### Modified Examples

An executing entity of each process described in the above-described exemplary embodiment is arbitrary, and is not limited to the above-described example. For example, a system having functions similar to those of the support apparatuses 1 and 1A can be constructed by a plurality of apparatuses capable of communicating with each other. The executing entity of each process illustrated in the flowchart of FIG. 5 may be one apparatus (also referred to as a processor) or a plurality of apparatuses (also referred to as processors).

### Example of Implementation Using Software

Some or all of the functions of the support apparatuses 1 and 1A may be achieved by hardware such as an integrated circuit (IC chip) or may be achieved by software.

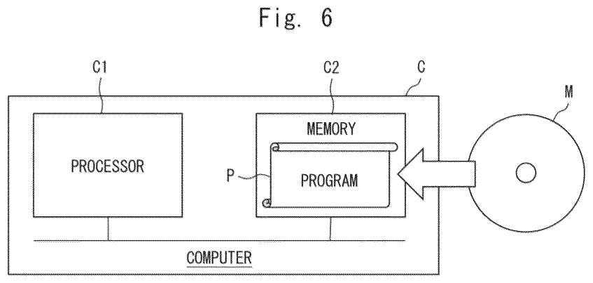

In the latter case, the support apparatuses 1 and 1A are implemented, for example, by a computer that executes a command of a program that is software for achieving each function. An example of such a computer (hereinafter, referred to as a computer C) is illustrated in FIG. 6. FIG. 6 is a block diagram illustrating a hardware configuration of the computer C functioning as the support apparatus 1 or 1A.

The computer C includes at least one processor C1 and at least one memory C2. A program P for causing the computer C to operate as the support apparatus 1 or 1A is recorded in the memory C2. In the computer C, the processor C1 reads the program P from the memory C2 and executes the program P, thereby achieving the functions of the support apparatus 1 or 1A.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used. As the memory C2, for example, a flash memory, a hard disk drive (HDD), a solid state drive (SSD), or a combination thereof can be used.

The computer C may further include a random access memory (RAM) for developing the program P at the time of execution and temporarily storing various types of data. The computer C may further include a communication interface for transmitting and receiving data to and from other apparatuses. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above-described functions of the support apparatus 1 or 1A may be achieved by a single processor provided in a single computer, may be achieved by a plurality of processors provided in a single computer in cooperation, or may be achieved by a plurality of processors respectively provided in a plurality of computers in cooperation. The program for causing the support apparatuses 1 and 1A to achieve each of the above-described functions may be stored in a single memory provided in a single computer, may be stored in a distributed manner in a plurality of memories provided in a single computer, or may be stored in a distributed manner in a plurality of memories respectively provided in a plurality of computers.

### Supplementary Notes

The whole or part of the example embodiments disclosed above can be described as, but not limited to, the following supplementary notes.

### Supplementary Note A1

A support apparatus that supports asset management, and including: reception means for receiving a request related to asset management from a support subject; and response control means for determining whether to cause an operator to respond to the request or to make an automatic response to the request according to content of the request.

### Supplementary Note A2

The support apparatus according to Supplementary Note A1, further including index value calculation means for calculating an index value for determining whether to switch to a response of the operator based on the content of the request of the subject during a period in which the automatic response is applied, in which the response control means determines whether to switch a response to the subject to the response of the operator based on the index value.

### Supplementary Note A3

The support apparatus according to Supplementary Note A2, in which, in a case where a new request from the subject is received, the index value calculation means updates the index value calculated most recently based on content of the new request, or recalculates the index value based on the content of the new request and content of a series of requests received until the new request is received.

### Supplementary Note A4

The support apparatus according to Supplementary Note A2 or A3, in which the index value calculation means calculates the index value by using an index value calculation model generated through machine learning of a relationship between a request from the subject supported for asset management and an index value indicating a necessity for the operator to respond to the request.

### Supplementary Note A5

The support apparatus according to any one of Supplementary Notes A1 to A4, in which the response control means determines whether a response to the subject is to be made by the operator or automatically, based on at least one of an evaluation result for a profit expected to be obtained by causing the operator to respond to the request of the subject or an evaluation result for a profit expected to be obtained by making an automatic response to the request of the subject.

### Supplementary Note A6

The support apparatus according to any one of Supplementary Notes A1 to A5, in which, in a case where content of the request of the subject is a request for a proposal of a financial product to be invested, the response control means determines to cause the operator to respond to the request.

### Supplementary Note A7

The support apparatus according to any one of Supplementary Notes A1 to A6, in which, in a case where content of the request of the subject indicates that a qualified person having a predetermined qualification is required to respond to the request, the response control means determines to cause the operator who is the qualified person to respond to the request.

### Supplementary Note A8

The support apparatus according to any one of Supplementary Notes A1 to A7, further including response evaluation means for evaluating validity of content of a response of the operator.

### Supplementary Note B1

A support method of supporting asset management, including: a reception process in which at least one processor receives a request related to asset management from a support subject; and a response control process in which the at least one processor determines whether to cause an operator to respond to the request or to make an automatic response to the request according to content of the request.

### Supplementary Note B2

The support method according to Supplementary Note B1, further including an index value calculation process in which the at least one processor calculates an index value for determining whether to switch to a response of the operator based on the content of the request of the subject during a period in which the automatic response is applied, in which, in the response control process, the at least one processor determines whether to switch a response to the subject to the response of the operator based on the index value.

### Supplementary Note B3

The support method according to Supplementary Note B2, in which, in a case where a new request from the subject is received, the at least one processor updates the index value calculated most recently based on content of the new request, or recalculates the index value based on the content of the new request and content of a series of requests received until the new request is received.

### Supplementary Note B4

The support method according to Supplementary Note B2 or B3, in which the at least one processor calculates the index value by using an index value calculation model generated through machine learning of a relationship between a request from the subject supported for asset management and an index value indicating a necessity for the operator to respond to the request.

### Supplementary Note B5

The support method according to any one of Supplementary Notes B1 to B4, in which, in the response control process, the at least one processor determines whether a response to the subject is to be made by the operator or automatically, based on at least one of an evaluation result for a profit expected to be obtained by causing the operator to respond to the request of the subject or an evaluation result for a profit expected to be obtained by making an automatic response to the request of the subject.

### Supplementary Note B6

The support method according to any one of Supplementary Notes B1 to B5, in which, in the response control process, in a case where content of the request of the subject is a request for a proposal of a financial product to be invested, the at least one processor determines to cause the operator to respond to the request.

### Supplementary Note B7

The support method according to any one of Supplementary Notes B1 to B6, in which, in the response control process, in a case where content of the request of the subject indicates that a qualified person having a predetermined qualification is required to respond to the request, the at least one processor determines to cause the operator who is the qualified person to respond to the request.

### Supplementary Note B8

The support method according to any one of Supplementary Notes B1 to B7, further including a response evaluation process in which the at least one processor evaluates validity of content of a response of the operator.

### Supplementary Note C1

A non-transitory computer readable medium storing a support program causing a computer to function as a support apparatus that supports asset management, the support program causing the computer to function as: reception means for receiving a request related to asset management from a support subject; and response control means for determining whether to cause an operator to respond to the request or to make an automatic response to the request according to content of the request.

### Supplementary Note C2

The non-transitory computer readable medium storing the support program according to Supplementary Note C1, in which the computer is caused to further function as index value calculation means for calculating an index value for determining whether to switch to a response of the operator based on the content of the request of the subject during a period in which the automatic response is applied, in which the response control means determines whether to switch a response to the subject to the response of the operator based on the index value.

### Supplementary Note C3

The non-transitory computer readable medium storing a support program according to Supplementary Note C2, in which, in a case where a new request from the subject is received, the index value calculation means updates the index value calculated most recently based on content of the new request, or recalculates the index value based on the content of the new request and content of a series of requests received until the new request is received.

### Supplementary Note C4

The non-transitory computer readable medium storing the support program according to Supplementary Note C2 or C3, in which the index value calculation means calculates the index value by using an index value calculation model generated through machine learning of a relationship between a request from the subject supported for asset management and an index value indicating a necessity for the operator to respond to the request.

### Supplementary Note C5

The non-transitory computer readable medium storing the support program according to any one of Supplementary Notes C1 to C4, in which the response control means determines whether a response to the subject is to be made by the operator or automatically, based on at least one of an evaluation result for a profit expected to be obtained by causing the operator to respond to the request of the subject or an evaluation result for a profit expected to be obtained by making an automatic response to the request of the subject.

### Supplementary Note C6

The non-transitory computer readable medium storing the support program according to any one of Supplementary Notes C1 to C5, in which, in a case where content of the request of the subject is a request for a proposal of a financial product to be invested, the response control means determines to cause the operator to respond to the request.

### Supplementary Note C7

The non-transitory computer readable medium storing the support program according to any one of Supplementary Notes C1 to C6, in which, in a case where content of the request of the subject indicates that a qualified person having a predetermined qualification is required to respond to the request, the response control means determines to cause the operator who is the qualified person to respond to the request.

### Supplementary Note C8

The non-transitory computer readable medium storing the support program according to any one of Supplementary Notes C1 to C7, wherein the computer is caused to further function as response evaluation means for evaluating validity of content of a response of the operator.

### Supplementary Note D1

A support apparatus that supports asset management, the support apparatus including at least one processor, in which the at least one processor executes: a reception process of receiving a request related to asset management from a support subject; and a response control process of determining whether to cause an operator to respond to the request or to make an automatic response to the request according to content of the request.

The support apparatus may further include a memory. The memory may store a program for causing the at least one processor to execute each of the processes.

### Supplementary Note D2

The support apparatus according to Supplementary Note D1, in which the at least one processor further executes an index value calculation process of calculating an index value for determining whether to switch to a response of the operator based on the content of the request of the subject during a period in which the automatic response is applied, in which, in the response control process, the at least one processor determines whether to switch a response to the subject to the response of the operator based on the index value.

### Supplementary Note D3

The support apparatus according to Supplementary Note D2, in which, in a case where a new request from the subject is received, the at least one processor updates the index value calculated most recently based on content of the new request, or recalculates the index value based on the content of the new request and content of a series of requests received until the new request is received.

### Supplementary Note D4

The support apparatus according to Supplementary Note D2 or D3, in which the at least one processor calculates the index value by using an index value calculation model generated through machine learning of a relationship between a request from the subject supported for asset management and an index value indicating a necessity for the operator to respond to the request.

### Supplementary Note D5

The support apparatus according to any one of Supplementary Notes D1 to D4, in which, in the response control process, the at least one processor determines whether a response to the subject is to be made by the operator or automatically, based on at least one of an evaluation result for a profit expected to be obtained by causing the operator to respond to the request of the subject or an evaluation result for a profit expected to be obtained by making an automatic response to the request of the subject.

### Supplementary Note D6

The support apparatus according to any one of Supplementary Notes D1 to D5, in which, in the response control process, in a case where content of the request of the subject is a request for a proposal of a financial product to be invested, the at least one processor determines to cause the operator to respond to the request.

### Supplementary Note D7

The support apparatus according to any one of Supplementary Notes D1 to D6, in which, in the response control process, in a case where content of the request of the subject indicates that a qualified person having a predetermined qualification is required to respond to the request, the at least one processor determines to cause the operator who is the qualified person to respond to the request.

### Supplementary Note D8

The support apparatus according to any one of Supplementary Notes D1 to D7, in which the at least one processor further executes a response evaluation process of evaluating validity of content of a response of the operator.

### Supplementary Note E

A non-transitory recording medium storing a program for causing a computer to function as a support apparatus that supports asset management, the program causing the computer to execute: a reception process of receiving a request related to asset management from a support subject; and a response control process of determining whether to cause an operator to respond to the request or to make an automatic response to the request according to content of the request.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. A support apparatus that supports asset management, the support apparatus comprising:
at least one memory storing instructions; and
at least one processor configured to execute the instructions to:
receive a request related to asset management from a support subject; and
determine whether to cause an operator to respond to the request or to make an automatic response to the request according to content of the request.

2. The support apparatus according to claim 1, the processor is further configured to execute the instructions to:
calculate an index value for determining whether to switch to a response of the operator based on the content of the request of the subject during a period in which the automatic response is applied, and
determine whether to switch a response to the subject to the response of the operator based on the index value.

3. The support apparatus according to claim 2, wherein, the processor is further configured to execute the instructions to, in a case where a new request from the subject is received, update the index value calculated most recently based on content of the new request, or recalculate the index value based on the content of the new request and content of a series of requests received until the new request is received.

4. The support apparatus according to claim 2, wherein the processor is further configured to execute the instructions to calculate the index value by using an index value calculation model generated through machine learning of a relationship between a request from the subject supported for asset management and an index value indicating a necessity for the operator to respond to the request.

5. The support apparatus according to claim 1, wherein the processor is further configured to execute the instructions to determine whether a response to the subject is to be made by the operator or automatically, based on at least one of an evaluation result for a profit expected to be obtained by causing the operator to respond to the request of the subject or an evaluation result for a profit expected to be obtained by making an automatic response to the request of the subject.

6. The support apparatus according to claim 1, wherein, the processor is further configured to execute the instructions to, in a case where content of the request of the subject is a request for a proposal of a financial product to be invested, determine to cause the operator to respond to the request.

7. The support apparatus according to claim 1, wherein, the processor is further configured to execute the instructions to, in a case where content of the request of the subject indicates that a qualified person having a predetermined qualification is required to respond to the request, determine to cause the operator who is the qualified person to respond to the request.

8. The support apparatus according to claim 1, the processor is further configured to execute the instructions to evaluate validity of content of a response of the operator.

9. A support method of supporting asset management, comprising:
a reception process in which at least one processor receives a request related to asset management from a support subject; and
a response control process in which the at least one processor determines whether to cause an operator to respond to the request or to make an automatic response to the request according to content of the request.

10. The support method according to claim 9, further comprising an index value calculation process in which the at least one processor calculates an index value for determining whether to switch to a response of the operator based on the content of the request of the subject during a period in which the automatic response is applied,
wherein, in the response control process, the at least one processor determines whether to switch a response to the subject to the response of the operator based on the index value.

11. The support method according to claim 10, wherein, in a case where a new request from the subject is received, the at least one processor updates the index value calculated most recently based on content of the new request, or recalculates the index value based on the content of the new request and content of a series of requests received until the new request is received.

12. The support method according to claim 10, wherein the at least one processor calculates the index value by using an index value calculation model generated through machine learning of a relationship between a request from the subject supported for asset management and an index value indicating a necessity for the operator to respond to the request.

13. The support method according to claim 9, wherein, in the response control process, the at least one processor determines whether a response to the subject is to be made by the operator or automatically, based on at least one of an evaluation result for a profit expected to be obtained by causing the operator to respond to the request of the subject or an evaluation result for a profit expected to be obtained by making an automatic response to the request of the subject.

14. The support method according to claim 9, wherein, in the response control process, in a case where content of the request of the subject is a request for a proposal of a financial product to be invested, the at least one processor determines to cause the operator to respond to the request.

15. The support method according to claim 9, wherein, in the response control process, in a case where content of the request of the subject indicates that a qualified person having a predetermined qualification is required to respond to the request, the at least one processor determines to cause the operator who is the qualified person to respond to the request.

16. The support method according to claim 9, further comprising a response evaluation process in which the at least one processor evaluates validity of content of a response of the operator.

17. A non-transitory computer readable medium storing a support program causing a computer to function as a support apparatus that supports asset management, the support program causing the computer to execute:
a reception process of receiving a request related to asset management from a support subject; and
a response control process of determining whether to cause an operator to respond to the request or to make an automatic response to the request according to content of the request.

18. The non-transitory computer readable medium storing the support program according to claim 17, wherein
the computer is caused to further execute an index value calculation process of calculating an index value for determining whether to switch to a response of the operator based on the content of the request of the subject during a period in which the automatic response is applied, and
in the response control process, the computer determines whether to switch a response to the subject to the response of the operator based on the index value.

19. The non-transitory computer readable medium storing the support program according to claim 18, wherein, in the index value calculation process, in a case where a new request from the subject is received, the computer updates the index value calculated most recently based on content of the new request, or recalculates the index value based on the content of the new request and content of a series of requests received until the new request is received.

20. The non-transitory computer readable medium storing the support program according to claim 18, wherein, in the index value calculation process, the computer calculates the index value by using an index value calculation model generated through machine learning of a relationship between a request from the subject supported for asset management and an index value indicating a necessity for the operator to respond to the request.
